(19) United States
(12) Patent Application Publication
(10) Pub. No.: US 2007/0100490 A1
(43) Pub. Date: May 3, 2007

(54) Method and apparatus for providing custom-cut film covering to a consumer

(76) Inventors: Timothy Hartt, San Antonio, TX (US); Ryan L. Pape, San Antonio, TX (US)

Correspondence Address: Thomas E. Sisson;Jackson Walker, LLP, Suite 2400, 112 E. Pecan, San Antonio, TX, 78205, US

(21) Appl. No.: 11/589,444

(22) Filed: Oct. 30, 2006

Related U.S. Application Data
(60) Provisional application No. 60/730,695, filed on Oct. 28, 2005.

(51) Int. Cl. G06F 19/00

(52) U.S. Cl. 700/134

(57) ABSTRACT

A method and apparatus for providing custom-cut film coverings to a customer includes providing to an input device or kiosk information relating to a desired film pattern for an object such as a vehicle window. Once the information is inputted, it may be confirmed, stored, and transferred to a pattern producing mechanism which initiates the operation of a cutter/plotter or printer. The printer generates a paper copy of the desired pattern, while the cutter/plotter generates a film covering substantially corresponding to the desired object pattern.

This application claims priority to U.S. Provisional Application Ser. No. 60/730,695, filed Oct. 28, 2005.

### FIELD OF THE INVENTION

Applicants' invention relates generally to providing custom-cut film products to a consumer. More specifically, the present invention relates to a kiosk—or web—based system wherein a consumer may provided detailed measurements of a plurality of windows and have custom-cut window tint produced therefrom.

### BACKGROUND OF THE INVENTION

Currently, a customer who wishes to have custom windows tinted or protected with a film must provide the retailer with window dimensions. Alternatively, an estimator/installer obtains the dimensions. These dimensions are then manually inputted by a skilled operator into a computer aided design device (commonly referred to as a CAD) which creates an electronic image which in turn may be inputted to a plotter/cutter. The plotter/cutter then generates the tangible sheet of film cut to the custom specifications. The film is then applied to the window by the customer or installer.

There is a need for a method and apparatus whereby the customer or estimator/installer may input the dimensions into an input device and directly receive the cut film without utilizing the services of a skilled operator. There is a further need that the cut film order may be created from a location remote from the source of the film and then sent to the requestor at the remote location.

### SUMMARY OF THE INVENTION

The present invention provides an in-store kiosk, a customized website, or other computer-based input system which allows retail store establishments to offer a fast, low maintenance, user-friendly system to provide custom-cut solar and security film to their customers. Generally, the system is comprised of a plotter/cutter, a supply of window tint or window security film in roll form (for example: 3M® Scotchshield® Safety & Security Film or 3M® Scotchtint® Sun Control Film), and a mechanism for receiving input from the consumer or estimator/installer. In the preferred embodiment, receiving mechanism will comprise a computer-based kiosk that resides at a retail location. In an alternate embodiment, the receiving mechanism (hereinafter “input device”) may comprise a website which accepts input from the consumer computer and delivers the relevant information to a retailer for production of the desired film product.

Using the input device, an employee or customer (hereinafter “operator”) enters via a keyboard or like device the relevant measurements (e.g., lengths, angles, etc.) of the windows to be tinted. After entering the measurements for all the desired windows, the present inventive system recognizes each set of dimensions as an image for a plotter/cutter and places each dimension window to be cut in a queue to be cut sequentially from a film source

### BRIEF DESCRIPTION OF THE DRAWINGS

FIG. 1 is a logic flow diagram illustrating one embodiment of the present invention.

FIG. 2 is a block diagram of one configuration of the present invention.

FIG. 3 is an alternative embodiment in a block diagram.

### DETAILED DESCRIPTION

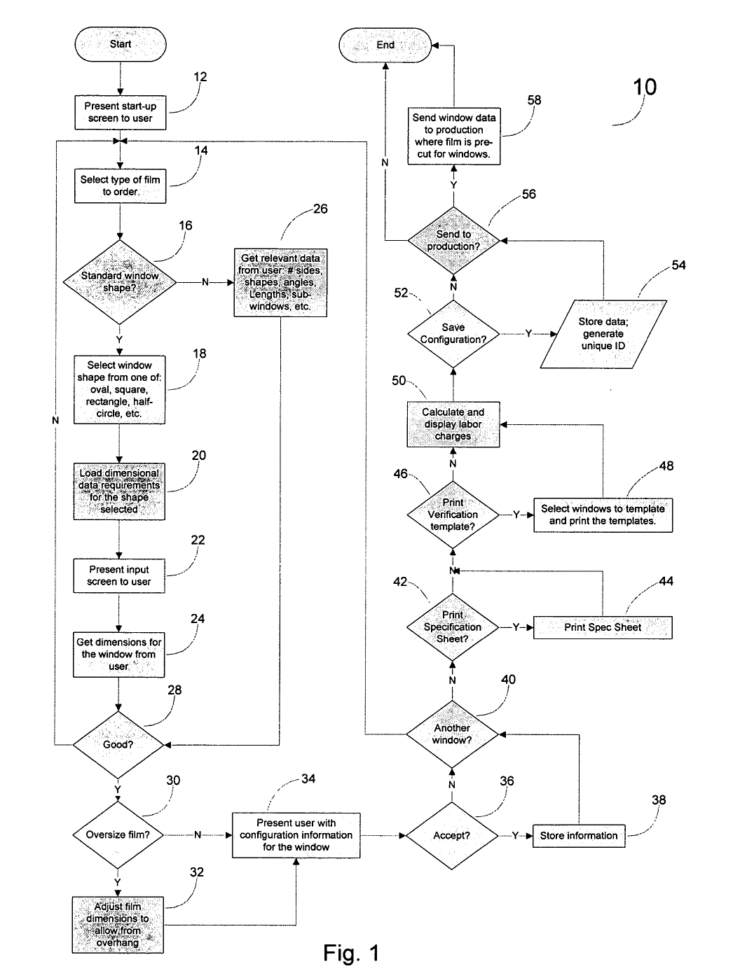

Referring now to FIG. 1 which illustrates one embodiment of a method (10) of providing custom-cut film products (including, but not limited to, window film) to a consumer. Initially, the customer is presented with a start-up screen (12) connected to a computer unit having an associated keyboard or like device. The screen may display a retailer's logo/trademark. The start-up screen (12) may also provide (display) the customer the option of selecting a language in which to operate, a unit of measure, or any other regionally variable item by using the keyboard or mouse.

The first step in placing an order is for the operator to select the type of film (14) desired from an availability list. Because the film types available will vary from retailer to retailer, this list is customizable and stored within a database or other repository of configuration information. A description, picture, or generic cost information may accompany the list of available films. Common films available include security and solar film, of varying thickness and transparency. The selection of film available is configurable by the retailer with no limits imposed by the current system.

Once the type of film to purchase has been selected, the operator is queried (16) as to whether the object (for example, window) to be filmed (for example, tinted) is a “standard” shape (e.g., square, rectangle, oval, circle, or a standard vehicle window style, etc.) for which standard measurements may be acquired or a “custom” object the shape of which must be described by the operator. For example, if the window shape is standard, the operator is prompted to select the shape from a provided list of standard window shapes(18). Based upon the standard window shape selected, the required measurement inputs are loaded into a pattern producing device from a local database or other repository (20). After selecting a generic shape of window (18), the operator is prompted to enter, if necessary, specific dimensions (22, 24) in the local (or previously selected) unit of measure based on the generic shape selected. For example, selecting a rectangular window would require input of both a length and a width, whereas selecting a square window would only require entry of one dimension.

For more complicated windows, operators may be required to enter more involved measurements (26), including but not limited to: angles, diagonal measurements and sub-component measurements (for windows containing multiple panes, etc).

All required measurements are indicated with both a text phrase (e.g., “width”) and graphically by, in the case of a rectangle, displaying on the screen a line spanning horizontally across a representative rectangle accompanying the text. In some embodiments of the present invention, operator may enter the dimensions through the use of a physical key-pad, a touch screen key-pad (a calculator like arrangement allowing for number entry), a touch-screen slider mechanism allowing customers to move up or down in predetermined fractional or decimal increments, or some other interface device. The retailer may provide to the operator a measurement sheet indicating the types of measurements required for the various generic window shapes. The measurement sheet may include specific measuring techniques for more complicated windows to be used internally by the system to derive angles and slopes.

Once all the measurements of the film to be ordered have been entered, the operator is prompted to confirm the accuracy of the entered measurements (28). If the measurements are not accurate, any given measurement may be adjusted by the operator or the “window” may be discarded and the process restarted.

After the operator approves the measurements (28), the operator is given the option to automatically enlarge the pattern of the film to be cut for the order to account for any mis-measurement or window size variance (30). If the user does choose to enlarge the pattern, the pattern is enlarged (32) on some or all sides, as determined by configuration or user preference, by a pre-determined or configurable amount, thereby allowing the film installer to trim the film to fit the window once the film is placed on the window. This is particularly useful for old windows, windows that are difficult to measure, or as an added “error” factor for less skilled installers.

The operator is presented with confirmation information (34) relating to the data entered for the order, including but not limited to, sale price, film type, and dimensions. If the operator agrees, acceptance is acknowledged to the computer. Once accepted (36), the operator may proceed with the existing order (38) or have the system disregard the information provided and return to the previous option. In addition, the operator has the option to order several copies of the configuration specified by incrementing a quantity selector provided along with the confirmation information.

The operator is then given the choice of adding another set of window information(40). If the operator decides to add another set of window data, the steps of the process to this point, from step 14 through 40, are repeated After entering the specific information for each desired window, the customer has the option to finalize the order. The customer may add, remove, or modify any set of window information previously entered by selecting the window from a list of all window sets.

In some embodiments, the operator has the option (42) to print a Specification Sheet (44) showing each of the sets of window data entered, including dimensions, film selections, and quantities. If the input source is a kiosk is properly equipped, this Sheet (44) is printed to a locally attached printer. If the input device is web-based, the sheet may be printed to the locally attached printer of the operator's computer. In alternate embodiments, the Specification Sheet may viewed only, e-mailed to an e-mail account, or saved electronically.

In some embodiments, the operator has the option (46) to print out a verification template (48) of the film the operator has created for a particular window. The verification template may be a paper or plastic representation of the window shape that will result from cutting the film pattern as described by the operator's input. If enabled by the retailer, for each window shape for which a verification template is to be produced, the system performs the internal calculations to vectorize the window shape specification into an internal image or pattern. The physical extents of the window shape are calculated to determine a maximum width and height of the window shape and amount of base film material to be cut, regardless of its actual shape.

In most instances, the window to be tinted will be too large to fit on any individual piece of printer paper standardly available. In those instances, the film pattern image is divided into a number of sub-pattern images based on the number of standard pieces of printer paper that will be required, once physically arranged in patchwork (tiled) fashion, to fully cover the extents of the previously vectorized internal window shape pattern. The exact number of sub-pattern images created will depend on the total window size and the size of the output printer which will print the individual tile or patchwork pages. Each sub-pattern image is printed onto an additional sheet of printer paper by the attached printer in a logical (e.g., left-to-right, top-to-bottom) order.

In some circumstances, the retailer may offer an installation service. In those circumstances, the operator using the present inventive method is given the opportunity to add the installation service to the order (50). The labor configuration is established by the retailer and stored in a local or remote database or other repository of configuration information. Numerous labor calculation methods are available, including hourly calculation, per-window flat fee calculation, and calculations based on total material usage. Additional options are available to the retailer to allow for adding trip or service charges, or the like. In any case, the computer may display upon the screen or printout the total fee for production and installation to be charged to the consumer.

The operator has the option (52) of saving the configured order for later retrieval and modification, to e-mail the configuration to another person (e.g., for further approval), or sending the order to production. Saving for later retrieval is an appropriate choice when the operator has chosen to print verification tiles and desires to ensure that the eventually cut film will fit the designated window shape. The operator may physically arrange the printed tiles in the order described allowing for the formation of an actual size representation of the film that will be produced from the station when the order is complete. The operator then places the assembled template over the designated window to ensure an accurate fit, returning to the kiosk (or website) to recall and modify the order if necessary.

Upon saving the configuration for later retrieval (54), the operator is given a unique coded identifier that can be used to retrieve the specific configuration at a later date. In alternate embodiments, the operator may designate or create the retrieval code so long as the code does not conflict with a previously assigned code. Depending on the station configuration, the code may be printed or displayed on-screen or both. Depending on station and retailer configuration, the unique code provided may be used to retrieve the window shape specification on-line at a website of the retailer's designation, or at another film cutting station in the same or another retail location. If installation service is desired, saving the configuration will allow for the installer using the coded identifier to retrieve the specification data it a later time when installation is actually performed. When an operator “recalls” the saved information, the operator may commence the process at the confirmation (34) step.

Finally, when actual production of cut film is desired (54), the system enters production mode (56) whereby the selected film configurations are realized internally as a vector image and sent to a plotter/cutter device. It is not required that all of the film configured be produced at any given time; a subset may be chosen for production. At this time, depending on configuration, and assuming the previous steps allowed for customer self-service, the operator may be prompted to find an associate at the retailer's facility to operate the production feature. The associate will enter a code or password to enter production mode.

Film configurations are first ordered for production by material type, sending out sequentially all patterns to be cut from the same base material and thereby minimizing film roll changes. Depending on the station-configuration, film may also be “nested” to minimize material waste. Nesting involves programmatically positioning the vectorized window shape patterns such that they fit together efficiently to offer a net reduction in linear film inches consumed.

The generated vector images are sent to the plotter in small batches (if patterns are nested and reasonable small) or one at a time (if patterns are larger), each time prompting the user (whether operator or associate) to input into the computer the success or failure of each plot after each has completed. If the user enters a failure, the user is given the opportunity to correct the problem and the system prompts the user to try again.

In some embodiments, after plotting is complete, the system may print a receipt containing the items ordered, the total price, one or more bar codes identifying the products purchased, the installation services ordered, or all of the above. In addition, statistical information such as the cost of materials used versus the price charged to the consumer may be collected and distributed to the retailer, wholesaler, or other party as desired. This information may be stored in a local database, a remote database, or e-mailed to appropriate recipients.

FIG. 2 illustrates in a block diagram one embodiment of the present invention. In FIG. 2, the in-store kiosk 100 is shown in the dashed line box connected to the database 110, which may also be situated in the same store. The kiosk 100 may include the data entry device 102, the computer 106, and the pattern producing device 108. The kiosk output may be connected to a printer 112, if a paper copy 113 of the pattern is desired, and/or a cutter 119 for generation of the desired film 115 the database 40, which may be connected to a data storage component 116 and a data reports generating component 118 the printer 112, cutter 114, data storage component 116, and data reports component 118 may be separate and distinct objects from the kiosk, if desired.

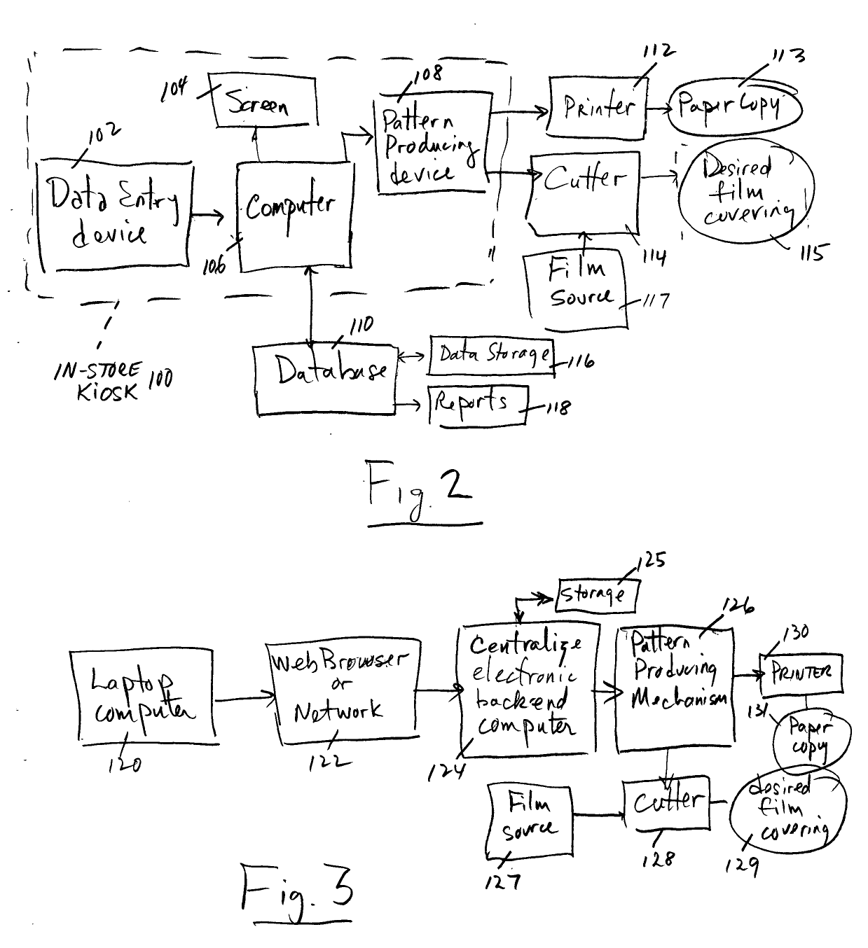

As an optional feature, in addition to the in-store workstation, through the use of a centralized electronic back-end, customers or installers may enter the window specification data on-line. FIG. 3 illustrates such an option. All information is stored centrally for future on-line or in-store retrieval. The web-based entry system may be branded to match a retailer's existing website. In some embodiments, with particular retailers, the web-based entry system may be hosted on the retailer's web server. The specification entry procedure is essentially identical to the kiosk-based system described above, except the input method is via web browser rather than a kiosk. Labor costing, saving, and template verification are all available on-line, depending on configuration. In order to be useful in a retail environment, the on-line order entry is generally combined with internet-enabled retail kiosks to retrieve the saved specification.

The web-based order entry process and its subsequent automatic vector pattern generation capability may be utilization of software based on customer or estimator input independent of the retail production station, to allow full-service window film installers to eliminate the need to manually create film patterns that will later be cut on the plotter/cutter for installation.

In another embodiment, the “input device” may be a laptop computer 120 (FIG. 3) that may or may not be in communicative contact with a back-end system 124 as described above. Where the laptop computer is not in communicative contact with a back-end system, all of features of the “input device”, as described in the preceding paragraphs are implemented in a “stand alone” system running on the laptop computer. When the operator has completed the acquisition of the relevant data, the operator may at a later time transmit that data to an appropriate back-end system for storage and production.

For example, an installation professional may visit the home of a consumer to measure the consumer's windows for filming. The data gathered may be stored in the installer's laptop computer 120 in the same fashion described above. Once the installation professional returns to the retail outlet, the input device (laptop) may be connected to a network 122 and all of the gathered information may then be transferred to a back-end system 124 for storage 125 or production 126.

In some embodiments, the present inventive system will maintain a database containing all of the pattern plots attempted, the window shape configuration data used, the required amount of material, and the success status recorded by the operator. Reports 118 (FIG. 2) may be generated that, when cross-referenced with actual film usage, can be used to determine waste or loss. Using this information, the system detects “low film,” “blade needs replacing,” and other error conditions, generating an operator alert report. Optionally, all of the above mentioned information could be sent or retrieved electronically if the station is web-enabled.

Depending on retailer configuration, for customers with windows having shapes which cannot be accurately defined using standard measurement techniques, a custom templating service may be available. Customers may obtain special templating paper directly from the retail outlet or on the web site. The customer takes a “rubbing” of the window, closely following a set of specific instructions. The rubbing is then scanned by the retailer or wholesaler to capture the window pattern data. The captured pattern may be uploaded onto a server for retrieval at any retail store, or a film cut and shipped directly to the consumer, using a unique identifier provided to or by the customer.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A method for providing custom-cut film coverings comprising the steps of:
providing to an input device information relating to a desired film pattern for an object to be covered;
providing a means for confirming said information conforms to the shape of said object;
transferring said confirmed information to a pattern producing mechanism;
supplying a source of film material; and
initiating operation of said pattern producing mechanism to cut said film from said film material source corresponding to said shape of said object.

2. An apparatus for providing custom-cut film coverings comprising:
a data entry member for inputting order information relating to a desired film pattern for an object to be covered to a computer;
a database operatively connected to said computer, said database containing sufficient information for generating an object pattern when combined with said order information in a pattern producing member, and
a cutter/plotter member operatively connected to said pattern producing member, said cutter/plotter adapted to cut a film covering substantially in the form of said desired film pattern.
